(19) United States
(12) Patent Application Publication
(10) Pub. No.: US 2025/0214893 A1
(43) Pub. Date: Jul. 3, 2025

(54) HIGH-PERFORMANCE CONCRETE AND ADMIXTURES

(71) Applicant: NZT Group Inc., Dover, DE (US)

(72) Inventor: Zachary B. Spencer, Dover, DE (US)

(21) Appl. No.: 19/008,559

(22) Filed: Jan. 2, 2025

Related U.S. Application Data
(60) Provisional application No. 63/616,975, filed on Jan. 2, 2024.

(51) Int. Cl. C04B 14/02; C04B 7/04; C04B 14/06; C04B 20/00; C04B 28/04; C04B 103/30; C04B 103/40; C04B 111/40

(52) U.S. Cl. CPC C04B 14/022; C04B 7/04; C04B 14/068; C04B 20/0048; C04B 28/04; C04B 2103/302; C04B 2103/304; C04B 2103/40; C04B 2111/40; C04B 2201/20; C04B 2201/50

(57) ABSTRACT

Disclosed herein are devices, systems, and methods related to an admixture for lightweight, high-performance concrete. The admixture can include a polymeric material; a surfactant; and graphene. In examples, when incorporated into a curable mixture and cured, admixing such admixtures result in a concrete that has a compression strength that is greater than the compression strength of an otherwise identical cured curable mixture that excludes the admixture, the compressive strength being at least 3,000 psi and a maximum density of about 150 lbs/ft³.

### CROSS-REFERENCE TO RELATED APPLICATION

This application claims the benefit of U.S. Provisional Patent Application No. 63/616,975, filed on Jan. 2, 2024, the entirety of which is incorporated herein by reference.

### FIELD OF THE INVENTION

The present invention relates to lightweight cement, and more particularly to admixtures, methods for making admixtures, and cementitious materials and articles made by admixing these admixtures.

### BACKGROUND

Concrete is a commonly used engineering material that can be quite heavy. Demands are high for lightweight concrete, specifically due to its desirable flexibility without compromising strength when compared to normal concrete. Such lightweight concrete is used in construction of modern structures that have small foundational cross sections or intricate designs for sleek foundation designs. For example, lightweight concrete has been used in high-rise buildings, long span bridges, offshore structures, sewer systems, among other things.

### SUMMARY

This disclosure provides a lightweight and/or foam concrete that has a lower thermal conductivity than prevailing conventional normal weight and lightweight concretes and provides a greater compressive strength than the current lightweight or foam concrete. Compositions and methods described herein provide a foam concrete that can be used to prepare slender structural components and the decrease in the size of the structural components compared to some current concretes decreases the overall cost of a structure. The compressive strength of the disclosed foam concrete is high enough to allow the foam concrete to be used for structural purposes as well as for masonry units, bricks, and insulating materials. Further, the thermal conductivity of the developed composition is lower (or conversely the R-value is higher) than that of the conventional concrete and some current lightweight concretes, which can result in significant conservation of energy due to the high thermal resistance of the developed composition.

### BRIEF DESCRIPTION OF THE DRAWINGS

FIG. 1 is a perspective view of concrete articles made with high-performance admixtures in accordance with principles of the present disclosure;

FIG. 2 is a perspective view of graphene-based cellular foam concrete articles made in accordance with principles of the present disclosure;

FIG. 3 is a chart showing a strength-gain curve for concretes made in accordance with principles of the present disclosure;

FIG. 4 is a diagram showing density per curing days for concretes made in accordance with principles of the present disclosure;

FIG. 5 is a chart showing density per curing days for concretes made in accordance with principles of the present disclosure; and

FIG. 6 is a chart showing an ASTM C39-01 standard test method for compressive strength of cylindrical concrete specimens for concretes made in accordance with principles of the present disclosure;

### DETAILED DESCRIPTION

The present disclosure relates to concrete formed by combining binding materials (e.g., cement) with aggregate, water, and admixture. Within a concrete mixture, the cement and water work together to form a paste or matrix that fills the voids between the aggregate particles and binds them together. The addition of admixture to concretes enhances their properties, such as workability, strength, and decrease viscosity.

Such high-performance concrete is lightweight and suitable to meet increasing demands, especially in the construction of high-rise buildings, offshore structures, and bridges due to its low density. Having low density advantageously results in a significant benefit in terms of load bearing elements of smaller cross section and a corresponding reduction in the size of the foundation. There are two ways to reduce the density of concrete: using light porous fillers or forming air voids. In this regard, admixtures (e.g., chemical and/or mineral admixtures) can be added to concrete to improve its behavior under various operational conditions.

Chemical admixtures reduce the cost of construction, modify properties of hardened concrete, ensure quality of concrete during mixing/transporting/placing/curing, and overcome certain emergencies during concrete operations. In examples, such admixtures can include surface active agents, a plasticizer, and/or a form-or clay-activity modifying agent. Chemical admixtures are used to improve the quality of concrete during mixing, transporting, placement and curing. They fall into the following categories: air entrainers, water reducers, set retarders, set accelerators, superplasticizers, specialty admixtures: which include corrosion inhibitors, shrinkage control, alkali-silica reactivity inhibitors, and coloring.

Mineral admixtures make mixtures more economical, reduce permeability, increase strength, and influence other concrete properties. Mineral admixtures affect the nature of the hardened concrete through hydraulic or pozzolanic activity. Pozzolans are cementitious materials and include natural pozzolans (such as the volcanic ash used in Roman concrete), fly ash and silica fume. They can be used with Portland cement, or blended cement either individually or in combinations. ASTM Categories-Concrete Admixtures, ASTM C494 specifies the requirements for seven chemical admixture types: Type A: Water-reducing admixtures, Type B: Retarding admixtures, Type C: Accelerating admixtures, Type D: Water-reducing and retarding admixtures, Type E: Water-reducing and accelerating admixtures, Type F: Water-reducing, high range admixtures, Type G: Water-reducing, high range, and retarding admixtures. Shrinkage Reducing Admixtures (SRA) and Mid-Range Water Reducers (MRWD) are two areas for which no ASTM C494-98 specifications currently exist.

Surfactants, which include substances that have a tendency to concentrate at surfaces or interfaces, can be used to entrain air voids in a fresh cementitious mixture or paste using surfactants. Surfactants carry and impart a charge to the surfaces to which they attach. Surfactants are classified as anionic (the surface-active portion of the molecule exhibits a negative charged), cationic (the surface-active portion bears positive charge), zwitterionic (both, positive and negative charges are presented in the surface-active portion), nonionic (the surface-active portion bears no apparent ionic charge). Their hydrophilic and hydrophobic nature of surfactant molecules determines their solutions behavior. Temperature also affects the solubility of surfactants. The solubility of ionic surfactants (anionic, cationic, and zwitterionic) increases rising the temperature while the solubility of nonionic surfactants decreases with rising temperatures. An exemplary surface active agent combination of the present invention therefore comprises (1) an air-entraining surface active agent comprising a betaine, alkyl and/or alkylaryl sulfonate, or mixture thereof; and (2) a nonionic oxyalkylene-containing polymer surfactant.

Accordingly, the present disclosure provides admixture compositions; cementitious compositions containing the exemplary admixture composition; and methods for controlling the amount and distribution of air voids in cementitious compositions (and in particular those integrated or admixed with the admixture composition). Example admixtures include (i) surfactant, (ii) graphene, (iii) basalt, and (iv) foaming agent or combinations thereof. For instance, a first admixture includes surfactant and graphene; a second admixture includes surfactant, graphene, and basalt; and a third admixture includes surfactant, graphene, basalt, and foaming agent. Other constituents (some of which are discussed elsewhere herein) can be added to provide unique solutions based on customer demands. For instance, optionally, a conventional air entraining agent (AEA) can be used or such an AEA can optionally be added separately into the concrete, cement, or cementitious composition being treated.

Hence, the admixture composition is incorporated into a hydratable cementitious composition, such as concrete or cement mortar, which optionally can contain a conventional air entraining agent (AEA) such as a water soluble salt (usually sodium) of a wood resin, wood rosin, or gum rosin; a non-ionic surfactant (e.g., such as those commercially available from BASF under the tradename TRITON X-100); a sulfonated hydrocarbon; a proteinaceous material; or a fatty acid (e.g., tall oil fatty acid) or its ester. The term “AEA” is used herein to mean and refer to a conventional air entraining agent, such as but not limited to one that has been identified above

In embodiments of the disclosure, the concrete formulations can contain one or more admixtures, non-limiting examples of such being retarding admixtures, accelerating admixtures, plasticizers, super plasticizers, water reducing admixtures and air-entraining admixtures. The admixtures are typically present at less than one percent by weight with respect to total weight of the composition, but can be present at from 0.1 to 4 weight percent.

Compositions and methods described in this disclosure provide for a foam concrete with constituents that include some or all of water, sand, Portland cement, basalt fiber, graphene, gypsum, and Aggragate. In examples, high-performance admixtures include polymers combined with graphene. This admixture enables a family of solutions that are among the lightest, non-corrosive and energy efficient with applications across a variety of infrastructures. In examples, dicyclopentadiene-(or “DCPD-”) based resins used in examples are environmentally friendly and have lower carbon emissions than steel. Example implementations disclosed herein can have the following characteristics: increased compressive, modulus, and tensile strength of concrete; superior crack control and shrink control; increased workability; ambient temperature control not required; ability to use non-potable, river, salt water and/or brackish water; use of local aggregates (reclaimed); reduced cure times; reduced carbon emissions; total cost reduction; and the like.

Example implementations can be used in a variety of applications, including integration into carbon negative concrete; roof decks, floor decks and tilt walls; geotechnical applications such as annular space filling in slip lining and void fill abandonment; architectural and precast applications; filling voids such as disused fuel tanks, sewer systems, pipelines and culverts; and the like. These graphene-based admixtures can be designed to meet client requirements. Made-to-order options include configurations such as water reducer, strength increaser, and density reducer, each of which can have low shipping/transport/handling costs.

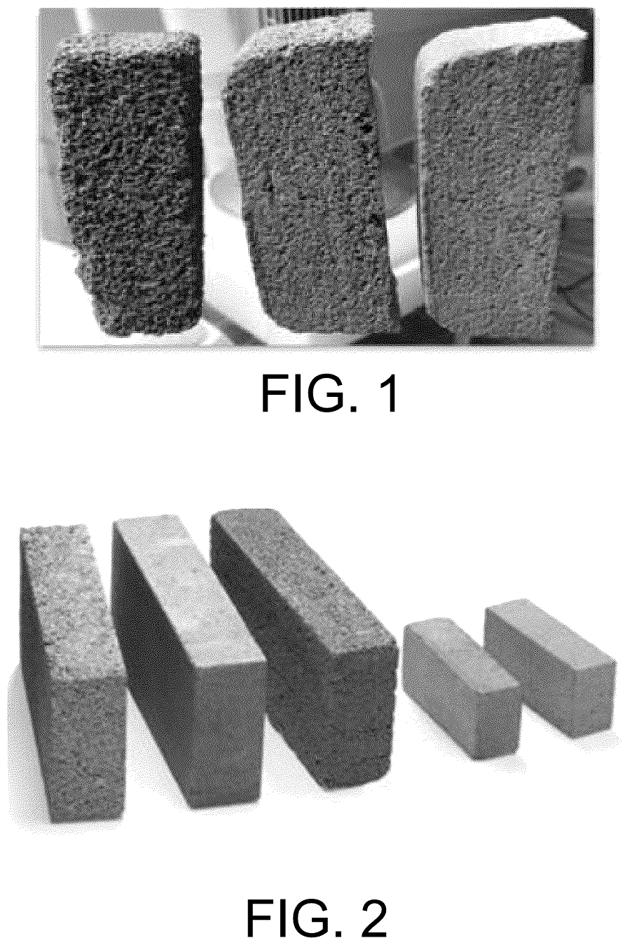

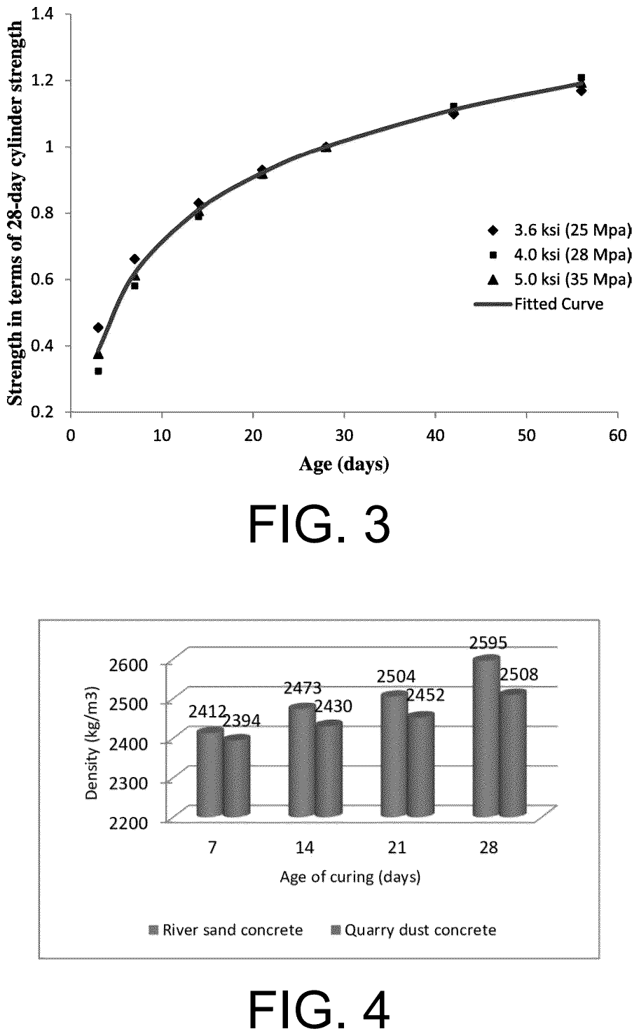

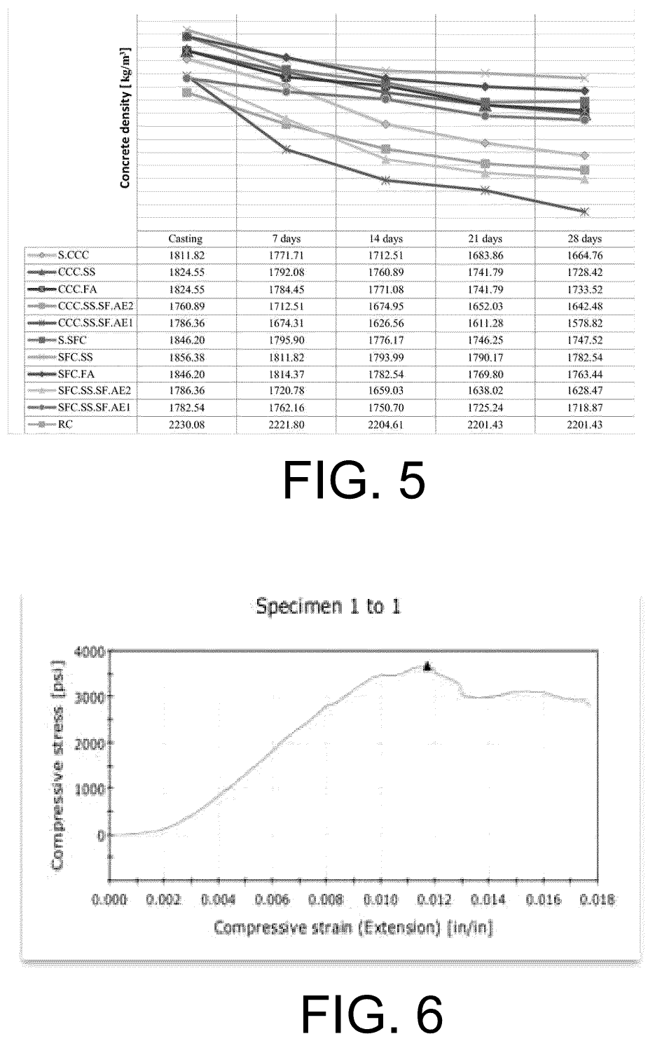

FIGS. 1-6 show various perspectives of principles of the present disclosure. In particular, FIG. 1 shows a perspective view of concrete articles made with high-performance admixtures in accordance with principles of the present disclosure. FIG. 2 shows a perspective view of graphene-based cellular foam concrete articles made in accordance with principles of the present disclosure. FIG. 3 is a chart showing a strength-gain curve for concretes made in accordance with principles of the present disclosure. FIG. 4 is a diagram showing density per curing days for concretes made in accordance with principles of the present disclosure. FIG. 5 is a chart showing density per curing days for concretes made in accordance with principles of the present disclosure. And FIG. 6 is a chart showing an ASTM C39-01 standard test method for compressive strength of cylindrical concrete specimens for concretes made in accordance with principles of the present disclosure;

Without general reference to these figures, in a first configuration (“Admixture 1”), the admixture can be designed as a density reducer. Admixture 1 can be lightweight, low-density, and high-strength. Under this circumstance, when admixed into a cementitious mixture, the resulting properties can include 3500+psi compression, density at 70-80 lbs/ft\hat{ }3, up to 80% strength in 5 days, less water used (e.g., when compared to similar mixtures without this admixture), and increased R-value for higher insulative properties.

In a second configuration (“Admixture 2”), the admixture can be designed as a strength increaser. Admixture 2 can be a high-strength admixture (e.g., when compared to other admixtures such as Admixtures 1 and 3 and/or concrete without any of these admixtures). Other properties can be similar to those of Admixture 1 in examples. Under these circumstances, Admixture 2 can have the following characteristics (e.g., when compared to other admixtures such as Admixtures 1 and 3 and/or concrete without any of these admixtures): less time to full strength, less water needed, and increased strength (e.g., compressive and tensile).

In a third configuration (“Admixture 3”), the admixture can be designed as a strength increaser. Admixture 3 can be a Water Reducer admixture (e.g., when compared to other admixtures such as Admixtures 1 and 2 and/or concrete without any of these admixtures) with less water, increased strength. Under these circumstances, Admixture 3 can have the following characteristics (e.g., when compared to other admixtures such as Admixtures 1 and 3 and/or concrete without any of these admixtures): less time to full strength, increases properties, and up to 25% time to full strength. Other properties can be similar to those of Admixtures 1 and 2 in examples.

Compositions and methods described in this disclosure provide for a foam concrete with constituents that include some or all of water, sand, Portland cement, basalt fiber, graphene, gypsum, and a foaming agent (such as Unifoam). Such compositions can be described as a graphene-based cellular foam concrete.

In examples, high-performance admixtures include polymers combined with graphene. This admixture enables a family of solutions that are among the lightest, non-corrosive and energy efficient with applications across a variety of infrastructures. In examples, dicyclopentadiene- (or “DCPD-”) based resins used in examples are environmentally friendly and have lower carbon emissions than steel. Example implementations disclosed herein can have the following characteristics: improved flexural strength & crack resistance; <28 day cure time; better heat dispersion; 30% water reduction; greater insulation; sound barrier; liquid & vapor barrier impermeability; antimicrobial/antifungal, anti-viral properties; and the like. #

Example implementations exhibit higher-strength performance and insulative properties (e.g., when compared to cementitious mixtures without the admixture). Resulting properties include: 3,500+psi compression, density at 70-80 lbs/ft\hat{ }3, up to 80% strength in 5days, less water used, and increased R-Value for higher insulative properties. Applications include: being integrated into Carbon Negative Concrete; roof decks, floor decks and tilt walls; geotechnical applications such as annular space filling in slip lining and void fill abandonment; architectural and precast applications; filling voids such as disused fuel tanks, sewer systems, pipelines and culverts; and the like.

Optionally, each of the compositions discussed herein can include basalt (e.g., hair, glass, or fibers). For instance, basalt chopped fibers can be mixed directly into polymers and concrete to increase tensile strength, reduce cracking and chipping and making stronger concrete without the limitations of steel. Chopped basalt fibers can be made from materials such as molten quarried rock while providing superior performance to fiberglass and steel in concrete. Basalt can also be in the form of rebar (e.g., made from rock or volcanics) designed to be tougher and stronger than steel with a higher tensile strength. Basalt can be in the form of a mesh (e.g., a composite mesh) or composite fiber mix with chopped fiber and basalt reinforced composite rebar. Products or structures built using basalt can avoid deteriorating construction and infrastructure resulting from the corrosion of steel, which decomposes from the elements, rain, wind, salt and chemicals. Corrosion worsens over time, and applying protective products or treatments in an attempt to slow the process can be expensive to install and upkeep. Basalt for concrete construction in place of steel results in non-corrosive products that prevent these issues and provide long-lasting, sustainable materials that eliminate the need for maintenance and replacement.

As used here, “concrete” is considered to include a composition made from cement, water, and aggregate or aggregates. While “aggregate” can be plural, the term “aggregates” generally refers to more than one type or more than one size of aggregate. Cement is a binder that can bind the aggregates together. Ordinary Portland cement is one such binder that can bind to other materials, such as fine and coarse aggregates, thereby holding them together. A material that is a paste that can harden to bind materials together, in the manner of cement, is said to be a cementitious material or to have cementitious properties. One of skill in the art will appreciate that water can be added to dry cement to make cement paste. The water-cement ratio (“w/c ratio”) of conventional normal weight concrete is typically between about 0.40 and 0.45. By way of explanation, a w/c ratio of 0.20 indicates that there is one part water to five parts Portland cement (1/5-0.20). A w/c ratio of 0.5 indicates one part water to two parts cement. The cement of embodiments of this disclosure can be, for example, a Type I Portland Cement. However, any type of cement, including a pozzolanic cement, can be used to produce lightweight concrete developed in this disclosure. In certain embodiments, pozzolanic material can alternately be used as a filler.

As one of ordinary skill will appreciate, various types of conventional aggregates can be used as a filler in the concrete. As one of skill in the art will appreciate, the term “aggregates” can refer to aggregate of multiple types or sizes. Aggregate can include, for example, sand, gravel, crushed rock, slag, or any other type of aggregate. When aggregate is used in concrete, the cement generally coats the aggregates and then binds them together in a matrix. When aggregates of various sizes are used, the smaller aggregate materials can fill voids between the larger aggregate materials, thus creating a denser matrix. The aggregates used in concrete can be defined in terms of coarse aggregate and fine aggregate. Fine aggregates, also referred to as “fines,” can include natural sand, crushed stone, or other suitable fine particles, with most particles smaller than 5 mm. Coarse aggregates generally include gravel or crushed stone with particles predominantly larger than 5 mm and typically between 9.5 mm and 37.5 mm.

In embodiments of the foam concrete of this disclosure, a coarse aggregate can be used that is cheap and readily available, such as limestone. The desired properties of the composition of this disclosure are achieved without the need for expensive or difficult to source aggregates. Compositions of this disclosure can include coarse aggregates with a density in a range of 60-160 lbs/ft³. Therefore, the desired weight and strength properties of the composition of this disclosure are achieved without the need for specialty or lightweight aggregates.

A foam solution can be used, such as a commercially available foaming agent that forms a solution when mixed with water. Commercially available foaming agents can be used, and in each case, prepared in accordance with the vendor instructions. As an example, compressed air can be introduced in the foaming agent plus water to form foam. Some examples can use soap. The water mixed with the foaming agent to form the foam solution is separate from the amount of water used as a separate constituent of the foam concrete, as described in this disclosure.

In example implementations of this disclosure, the foam concrete is prepared without the use of an air-entraining agent. An air-entraining agent is used to create air bubbles that can accommodate the formation of ice under freezing temperatures. The use of a foaming agent forms smaller size air voids that contribute to a lighter concrete. The air voids formed due to the use of an air-entraining agent are bigger in size than those formed due to the use of a foaming agent. Therefore, an air-entraining agent would not be desirable in the foam concrete of the current application.

In preparing foam concrete in accordance with embodiments of this disclosure, the range of wt % for each constituent—such as cement, sand, water, and/or foam solution-can be found in the tables below. While coarse aggregate may be included in some mixtures, it is not always used and may not be necessary for all applications. As used in this disclosure, the unit wt % is measured relative to the weight of the concrete.

TABLE 1
Cementitious Mixtures

| | 4000 psi | | |
|---|---|---|---|
| | min | | |
| Concrete | qty | unit | % weight |
| Water | 1400 | g | 3.0294% |
| Sand | 3000 | g | 6.4915% |
| Portland | 2000 | g | 4.3277% |
| cement | | | |
| Basalt Fiber | 150 | g | 0.3246% |
| Graphene | 2 | g | 0.0043% |
| Gypsum | 50 | g | 0.1082% |
| Agragate | 39612 | g | 85.7143% |
| total weight | 46.214 | kg | |
| Density | 150 | lbs/ft³ | |
| | 2406.4 | kg/m³ | |
| | factor | 52.07 | |
| | 2000 psi | | |
| | min | | |
| Foamed | qty | Unit | |
| Water | 1400 | G | 21.2057% |
| Sand | 3000 | G | 45.4408% |
| Portland | 2000 | G | 30.2939% |
| cement | | | |
| Basalt Fiber | 100 | G | 1.5147% |
| Graphene | 2 | G | 0.0303% |
| Gypsum | 50 | G | 0.7573% |
| Merlcrete | 50 | G | 0.7573% |
| Total weight | 6.602 | Kg | |
| Density | 80 | lbs/ft³ | |
| | 1283.4 | kg/m³ | |
| | factor | 194.4 | |

Tested specimen using the above constituents have a sufficient compressive strength to be used as a structural member. Foam concrete in accordance with embodiments of this disclosure can be lighter than traditional structural concretes that have a comparable compressive strength by more than 30%, providing a lighter weight product overall. In addition, foam concrete in accordance with embodiments of this disclosure can have a thermal conductivity that is 50% less than the thermal conductivity of traditional normal weight structural concretes. The decrease in the unit weight and thermal conductivity of the disclosed foam concrete reduces the weight of the concrete members, leads to energy conservation, and reduces the overall cost of the infrastructure. Therefore, embodiments of this disclosure can be utilized to produce lighter concrete elements with good compressive strength and better insulation properties or structural applications and in concrete masonry units, bricks and for insulation purposes. The performance of the produced mix of this application is better than that of the conventional foam concrete in terms of strength, it is lighter than the conventional concrete, and has better thermal properties than conventional concrete.

The following are examples that demonstrate the principles of this disclosure in action. Some of the described implementations involve methods, devices, and systems (including computer-based systems) designed to carry out specific tasks or functions. For example, an admixture (a mix-in material) may include a combination of polymeric material, a surfactant (a substance that reduces surface tension), and graphene (a strong and lightweight material). When this admixture is added to a concrete mixture and allowed to cure (harden), the resulting concrete can be stronger than the same mixture without the admixture. Specifically, the cured concrete can achieve a compressive strength (the ability to withstand squeezing forces) of at least 3,000 psi, with a maximum density of about 150 lb/ft³. Additionally, this technology could involve related computer systems, devices, and software programs that help carry out the methods. In such systems, software or hardware enables the system to perform the necessary steps, such as managing the mixing or curing process. These computer programs work by providing instructions that, when executed by the computer, ensure the required actions are carried out.

Implementations may include one or more of the following features. Admixture where a cure time for the curable mixture is less than or equal to 28 days. Admixture where the admixture is integrated into a concrete product formed using the admixture. Admixture that includes at least one of basalt and a foaming agent. Implementations of the described techniques may include hardware, a method or process, or a computer tangible medium.

Implementations may include one or more of the following features. Admixture where the admixture is at least one of a density-reducer admixture, a strength-increaser admixture, and a water-reducer admixture. Admixture where incorporation of the density-reducer admixture into the curable mixture results in an increased R-value of the concrete than that of an otherwise identical concrete cured from a curable mixture that incorporates either the strength-increaser admixture or the water-reducer admixture. Admixture where incorporation of the density-reducer admixture into the curable mixture results in a reduced time to 80% full strength of the concrete than that of an otherwise identical concrete cured from a curable mixture that incorporates either the strength-increaser admixture or the water-reducer admixture. Admixture where the reduced time to 80% full strength is about 5 days. Admixture where incorporation of the strength-increaser admixture into the curable mixture results in a concrete with at least one of: less time to full strength when cured than that of an otherwise identical curable mixture that incorporates the density-reducer admixture; and increased strength of the curable mixture when cured than that of an otherwise identical curable mixture that incorporates either the density-reducer admixture or the water-reducer admixture. Admixture where the increased strength includes increased compressive and tensile strength. Admixture where incorporation of the water-reducer admixture into the curable mixture results in a concrete with at least one of: less time to full strength when cured than that of an otherwise identical curable mixture that incorporates the density-reducer admixture; and increased time to full strength of the curable mixture when cured than that of an otherwise identical curable mixture that incorporates either the density-reducer admixture or the strength-increaser admixture. Admixture where the increased time to full strength is about 25% increased time to full strength. Implementations of the described techniques may include hardware, a method or process, or a computer tangible medium.

In one general aspect, concrete may include 2% to 6% of a cement. Concrete may also include 4% to 8% of a sand. Concrete may furthermore include 83% to 87% of an aggregate. Concrete may in addition include 1 to 5% of a water. Concrete may moreover include 0.05% to 0.015% of a gypsum. Concrete may also include 0.002% to 0.006% of graphene. Concrete may furthermore include where the concrete has a time to full cure of less than or equal to 28 days and is 50 to 80% full strength with 5 days of cure time. Concrete may in addition include where the concrete has a compressive strength of greater than or equal to 3,000 psi at full cure. Other embodiments of this aspect include corresponding computer systems, apparatus, and computer programs recorded on one or more computer storage devices, each configured to perform the actions of the methods.

In one general aspect, concrete may include 28% to 32% of a cement. Concrete may also include 43% to 47% of a sand. Concrete may furthermore include 0.5% to 1% of a Merlcrete. Concrete may in addition include 19 to 21% of a water. Concrete may moreover include 5% to 9% of a gypsum. Concrete may also include 0.01% to 0.005% % of graphene. Concrete may furthermore include where the concrete has a time to full cure of less than or equal to 28 days and is 50 to 80% full strength with 5 days of cure time. Concrete may in addition include where the concrete has a compressive strength of greater than or equal to 3,000 psi at full cure. Other embodiments of this aspect include corresponding computer systems, apparatus, and computer programs recorded on one or more computer storage devices, each configured to perform the actions of the methods.

Implementations may include concrete with 0.1% to 5% basalt fiber.

Various methods can be used to prepare an ultra-light cementitious composition. A method of forming a concrete can include the steps of mixing together some or all of the following constituents: a cement; a sand; an aggregate; a water; and a foaming agent. Adding a foam solution that includes a foaming agent and a foaming water will facilitate making a foam concrete.

In other examples, all dry components can be preblended and provided in a package. Alternatively, all components including a surfactant mixture and water can be provided in the same mixture. At least in some embodiments, a bucket mixing with a drill and a rubber disk can be used. In this method, a rubber disk is used to form foam by mixing water with an anionic/non-ionic surfactant mixture. After the foam is generated, other components such as cement are added, and the mixture is blended together in a mixer until the resulting slurry is well blended.

Various poured products such as doors, garage door panels, wall partition systems, ceiling panels, gun safes, file cabinets, and other fire-rated applications can be prepared with an ultra-light cementitious composition. Such products, including doors, partitions, and panels, can be manufactured off-site and shipped to a construction location. In some embodiments, poured products such as flooring and wall partitions may also be poured directly at the construction site. While this technology is versatile across industries, specific applications, including those relevant to data centers, could be explored to meet industry-specific needs.

At least in some methods, a poured product is obtained by pouring an ultra-light cementitious composition onto a substrate. Such substrate may include at least one mat on top of which an ultra-light cementitious composition is poured. In some embodiments, a pourable product is obtained by pouring an ultra-light cementitious composition onto one piece of a substrate and then covering the poured composition with another piece of a substrate. Various substrates can be used, including without limitation, paper, wood, plywood, oriented strand board, glass fiber mats, plastic mats and metal plates.

In other embodiments, an ultra-light cementitious composition can be poured into a cast or mold or frame. This method is suitable for example for preparing wall partitions. A cast can be made of wood, plywood, plastic, metal and any other material commonly used in construction. A cast can be removed after the composition sets. In other embodiments, a cast can be designed such that it stays as a part of a finished poured product.

In some embodiments, an ultra-light cementitious composition can be used as a self-drying deep fill material which can be poured or pumped as a flooring composition onto a substrate.

The term “Portland cement” as used herein means the general composition as generally described in the Background section. This term includes hydratable cement which is produced by pulverizing clinker consisting of hydraulic calcium silicates and one or more forms of calcium sulfate (gypsum) as an interground additive.

The term “cementitious” as used herein can refer to materials that comprise Portland cement or which otherwise function as a binder to hold together fine aggregates (e.g., sand), coarse aggregates (e.g., crushed gravel), or mixtures thereof. Such cementitious materials may further include fly ash, granulated blast furnace slag, limestone, silica fume, or other pozzolans or pozzolanic material which may be combined with Portland cement or be used to replace or substitute for a portion of the Portland cement without serious diminishment of hydratable properties.

The term “hydratable” as used herein is intended to refer to cement or cementitious materials that are hardened by chemical interaction with water. Portland cement clinker is a partially fused mass primarily composed of hydratable calcium silicates. The calcium silicates are essentially a mixture of tricalcium silicate (3CaO·SiO2) and dicalcium silicate (2CaO·SiO2) in which the former is the dominant form.

The term “slurry” is often used herein to refer to a cementitious slurry, or paste, which is formed by mixing together the cementitious material (e.g., Portland cement or other cementitious material alone, or a mixture of Portland cement and one or more other cementitious materials) with water to initiate the hydration (or curing) reaction which results in a hardened cementitious mass or structure. The terms “structure” and “article” may be used interchangeably herein.

The term “mortar” as used herein will typically refer to a cement, cementitious mixture, or cementitious slurry having a fine aggregate, such as sand, while the term “concrete” will refer to a mortar further comprising a coarse aggregate, such as crushed stones or gravel. Hence, it will be understood that the present invention will also provide cementitious foam mortars and concretes by combining the cementitious foam slurry with conventional mortars and concretes. Exemplary lightweight mortars and concretes can also be achieved by optionally incorporating lightweight aggregates (e.g., polystyrene beads) with cementitious foam slurries made in accordance with the present invention.

The exemplary foam composition can be introduced, either in dry powder or wet (foamed) form, into conventional mortars and concretes to generate light weight structures and articles (products), and, more preferably, are combined with cementitious slurry-generating component systems of the invention, which comprise an expansive agent and a borate compound.

The components of the exemplary cementitious foam composition of the invention may be in dry powder form. For example, dry components may be packaged as a unitary mixture to which water can be incorporated and mixed to generate cementitious foam slurry.

Alternatively, components dry, foam-generating components may be packaged separately as a foam-generating component system, and slurry-generating components may be packaged separately as a slurry-generating component, with a plurality of microfibers being packaged with either or with both of them. In further exemplary embodiments, it is similarly possible to package the calcium salt (e.g., calcium nitrite) in either or both of the foam and slurry systems. Additionally, the PC surfactant foam generating component can be included in the cementitious slurry system as well as in the foam system.

Whether packaged in separate containers or in a single container, the dry formulation can be combined with water, at the factory or at the application site, to generate hydratable cementitious foam that can be molded into shape prior to setting and hardening into final shape. For example, the separate foam and slurry components can be mixed with water separately and are stable and when combined provide several minutes of working time for pouring into a form (mold) or cavity or pumping for injection into a mold or for spray application against a surface or substrate. Alternatively, all the materials can be mixed together with water and then the foam volume enhanced, a static mixer where air and liquid are sent through a porous medium or tortuous path to produce foam, or through an air injected hose and nozzle.

High-performance foamed concrete formulations utilize innovative material combinations to achieve optimized strength, weight, and durability. These formulations, categorized into high-strength and mid-range mixes, incorporate novel constituents such as graphene and rice husk ash alongside traditional and non-traditional binders to create lightweight yet structurally robust cementitious compositions.

The high-strength formulation delivers superior compressive strength while maintaining lightweight characteristics. The mixture achieves this through a balanced combination of materials. Key components include 7 pounds of Portland cement, a widely used binder in cementitious materials, and 7 pounds of rice husk ash, which acts as a supplementary pozzolanic material to enhance the mix's strength and durability. Coarse lava rock, incorporated at 4 pounds, serves as a lightweight aggregate, reducing the density of the mix without compromising structural integrity. Similarly, 3 pounds of clay introduces fine particulates that contribute to improved workability and adhesion properties. The inclusion of 0.275 pounds of basalt fiber provides tensile reinforcement, counteracting the brittle nature of traditional cementitious materials.

This formulation incorporates advanced chemical and nanomaterial admixtures. Graphene, at a weight of 0.05 pounds, enhances the mix's mechanical properties, including compressive strength and crack resistance, due to its high strength-to-weight ratio and nanoscale reinforcement effects. The addition of 0.75 pounds of polycarboxylate ether (PCE) acts as a high-range water reducer, improving the mix's flow and reducing water demand. The foam, comprising 0.4 pounds, is critical in generating the cellular structure characteristic of foamed concrete, enabling density reduction to 91.64 lbs/ft³ (2474.28 lbs/yd³). The total weight of 33.1586 pounds ensures a well-balanced mixture for high-strength applications, with an estimated volumetric scalability indicated by the scaler value of 0.610933333.

The mid-range formulation provides a balance between performance and cost-efficiency, suitable for less demanding structural applications. While maintaining the same 7 pounds of Portland cement and 7 pounds of rice husk ash, this mix employs fine lava rock as the aggregate, reflecting a finer gradation for smoother finishes and better compaction. The reduced foam content of 0.1 pounds compared to the high-strength mix results in a slightly denser product at 81.36 lbs/ft³ (2196.72 lbs/yd³). Water content is notably lower at 4 pounds, resulting in a less fluid mixture, suitable for applications where precision placement and reduced shrinkage are priorities. The remaining components, including clay, basalt, graphene, and PCE, retain the proportions of the high-strength mix, ensuring consistency in performance metrics such as tensile reinforcement and workability.

These formulations achieve compressive strength and durability suitable for structural and non-structural applications. The high-strength mix is ideal for demanding uses such as load-bearing walls or lightweight yet high-strength infrastructure. The mid-range mix, with its reduced density and cost-effective material balance, is optimized for general-purpose applications, such as non-load-bearing partitions or insulation panels. Both formulations demonstrate exceptional performance metrics due to the synergistic effects of advanced admixtures and innovative material selections. The use of graphene and PCE, in particular, highlights the technological advancement of these mixes over conventional foamed concrete.

These high-performance formulations align with lightweight cementitious material applications, offering enhanced strength-to-weight ratios critical for modern construction. Their adaptability in density and strength profiles makes them suitable for a wide range of applications, including residential, commercial, and industrial projects. Furthermore, the inclusion of sustainable materials such as rice husk ash promotes eco-friendly construction practices. The described formulations provide tailored solutions for diverse structural and non-structural applications, delivering on performance, sustainability, and cost-effectiveness.

TABLE 2
Formulation Table

| | High-Strength | Mid-Range |
|---|---|---|
| Component | Mix (lbs) | Mix (lbs) |
| Portland | 7.000 | 7.000 |
| Lava Rock (Coarse/Fine) | 4.000 (Coarse) | 4.000 (Fine) |
| Rice Husk Ash (Coarse/Fine) | 7.000 (Coarse) | 7.000 (Fine) |
| Clay (Coarse) | 3.000 | 3.000 |
| Basalt | 0.275 | 0.275 |
| Quicklime | 3.000 | 3.000 |
| Sodium Lignosulfonate | 0.000 | 0.000 |
| Graphene | 0.050 | 0.050 |
| Water | 7.6836 | 4.000 |
| Foam | 0.400 | 0.100 |
| PCE | 0.750 | 0.750 |
| Total Weight | 33.1586 | 29.175 |
| Density (lbs/ft³) | 91.64 | 81.36 |
| Density (lbs/yd³) | 2474.28 | 2196.72 |
| Scaler | 0.610933333 | — |

The disclosed formulations and methods for producing foamed concrete using carbon dioxide gas focus on the enhancement of structural properties while mitigating environmental impacts. Traditional foamed concrete, made by incorporating air into a cementitious mixture, often suffers from variability in foam stability and strength. By introducing carbon dioxide gas into the mixture, a stable foam structure is achieved, and carbonation reactions are leveraged to form calcium carbonate within the matrix. This process not only strengthens the material but also sequesters carbon dioxide, contributing to sustainability in construction materials.

The integration of barium sulfate into concrete compositions further demonstrates an approach to improving material performance by addressing thermal regulation. Barium sulfate is incorporated in concentrations ranging from 5% to 25% by weight of the cementitious binder to enhance solar reflectivity and reduce heat absorption. When applied as a surface coating, barium sulfate maximizes solar reflectance while maintaining the durability of the concrete. This dual application method reduces surface temperatures in exposed structures and mitigates urban heat island effects, offering a versatile solution for both new and existing concrete installations.

Methods for combining foamed concrete formulations with carbon dioxide and barium sulfate-enhanced compositions provide additional functionality. For example, introducing barium sulfate into the cementitious mixture used in carbon dioxide foaming processes can address not only strength and environmental impact but also thermal regulation. The addition of barium sulfate as a fine aggregate or surface coating in foamed concrete could further reduce heat absorption without compromising the stability or mechanical integrity provided by the carbonation reactions.

The use of barium sulfate as an alternative or complementary material to basalt fibers, as disclosed in the foamed concrete methods, also offers strategic advantages. Basalt fibers, included for tensile reinforcement in foamed concrete, can be partially replaced by barium sulfate in applications where thermal performance is a priority. The synergy between the reflective properties of barium sulfate and the compressive strength improvements from carbon dioxide-induced carbonation presents an opportunity to tailor the material properties of foamed concrete for specific applications such as outdoor pavements or load-bearing walls in high-temperature environments.

The modular nature of these disclosed compositions and methods allows for their seamless integration or substitution based on project-specific needs. For instance, a formulation that employs both carbon dioxide foaming and barium sulfate-enhanced coatings could achieve superior performance metrics, such as reduced surface temperatures, higher compressive strength, and improved environmental sustainability. These innovations collectively demonstrate the adaptability and scalability of advanced cementitious materials, ensuring their applicability across diverse construction scenarios while addressing modern challenges of performance and sustainability.

The process of introducing carbon dioxide gas into a cementitious mixture is carefully controlled to ensure uniform dispersion and optimal reaction conditions. The gas concentration and injection pressure are adjusted based on the specific properties of the mixture, ensuring a stable foam structure that maintains the intended mechanical integrity. The subsequent carbonation reaction, where carbon dioxide reacts with calcium hydroxide to form calcium carbonate, is optimized through precise curing conditions involving controlled temperature and humidity. This controlled process results in foamed concrete with enhanced strength, reduced shrinkage, and improved resistance to environmental degradation.

The incorporation of graphene into foamed concrete formulations offers additional benefits by improving the material's tensile strength, thermal conductivity, and durability. Graphene's nanoscale reinforcement properties complement the carbonation reactions induced by carbon dioxide, creating a composite material with superior mechanical and thermal properties. When combined with barium sulfate, graphene can further enhance the thermal regulation capabilities of the concrete, making it suitable for a wider range of applications, including high-performance infrastructure and energy-efficient buildings.

Alternative admixtures, such as sodium lignosulfonate, can be included in the disclosed formulations to modify the workability and setting time of the foamed concrete. While sodium lignosulfonate is not included in the specific examples provided, its potential use highlights the flexibility of the methods in accommodating different project requirements. By tailoring the admixture composition, the properties of the foamed concrete can be adjusted to meet the specific needs of applications ranging from lightweight insulation panels to structural load-bearing components.

The use of fine aggregates, such as rice husk ash and fine lava rock, enhances the overall performance of the foamed concrete by improving its density and compressive strength. Rice husk ash, a sustainable byproduct, provides additional pozzolanic activity, which contributes to the long-term strength development of the material. Fine lava rock, on the other hand, ensures a smooth surface finish and uniform distribution of voids within the foamed matrix, further enhancing its structural integrity.

The application of barium sulfate as a surface coating on foamed concrete structures provides immediate and long-term benefits. The high-purity barium sulfate layer forms a reflective barrier that minimizes solar heat absorption and protects the underlying concrete from weathering and ultraviolet radiation. This dual functionality not only enhances the lifespan of the structure but also reduces cooling energy costs in hot climates. The compatibility of the barium sulfate coating with various binder systems, including epoxy and latex-modified cement, ensures its applicability across a range of construction scenarios.

The integration of quicklime into the foamed concrete formulations facilitates the carbonation process by increasing the availability of calcium ions for reaction with carbon dioxide. Quicklime also contributes to the initial strength development of the mixture, making it particularly beneficial in applications where early strength is a priority. The synergy between quicklime, carbon dioxide, and other admixtures demonstrates the potential of the disclosed methods to create high-performance materials tailored to specific construction needs.

The scalability of the disclosed methods for producing foamed concrete using carbon dioxide extends their applicability to large-scale industrial production. By utilizing existing infrastructure for cement and concrete production, the methods can be implemented with minimal modifications, reducing costs and facilitating widespread adoption. The environmental benefits, including carbon sequestration and reduced energy consumption, further enhance the appeal of these methods for sustainable construction practices.

The combination of carbon dioxide foaming with barium sulfate-enhanced compositions opens new possibilities for multifunctional concrete materials. For instance, a hybrid formulation that incorporates both technologies could be used to construct energy-efficient buildings with improved thermal performance and structural durability. Such materials would be particularly valuable in regions with extreme temperature variations, where both thermal regulation and mechanical resilience are critical.

The potential for customization within the disclosed formulations allows for the development of specialized concrete products tailored to niche applications. For example, the inclusion of hydrophobic additives in the foamed concrete mixture could create water-resistant materials suitable for marine or flood-prone environments. Similarly, the incorporation of phase-change materials alongside barium sulfate could further enhance the thermal performance of the concrete, providing passive temperature regulation in energy-efficient buildings.

The disclosed methods also have significant implications for reducing the environmental impact of the construction industry. By sequestering carbon dioxide within the concrete matrix and utilizing sustainable materials such as rice husk ash, the methods contribute to the development of eco-friendly construction materials. The reduced reliance on traditional aggregates and the incorporation of industrial byproducts further align with global efforts to promote sustainability and reduce carbon emissions in construction.

These advanced formulations and methods for producing foamed concrete demonstrate a comprehensive approach to improving the performance, versatility, and sustainability of cementitious materials. By integrating innovative technologies such as carbon dioxide foaming, barium sulfate enhancement, and graphene reinforcement, the disclosed methods offer a pathway to creating next-generation construction materials that meet the evolving demands of the industry.

This write-up provides a detailed explanation of a novel cooling technology that leverages the natural phenomenon of radiative cooling to enhance energy efficiency in air conditioning and refrigeration systems. The system utilizes multilayer optical films applied to panels designed to reflect sunlight and emit infrared radiation, effectively dissipating heat into the cold expanse of space. This approach allows the panels to provide cooling without relying on significant electrical input, apart from a small circulating pump, and without water evaporation, ensuring a sustainable and efficient operation.

The technology operates continuously, providing cooling effects during both day and night. During the day, the panels reflect incoming solar radiation, reducing heat absorption, while simultaneously emitting thermal radiation to the sky. This dual functionality enables the panels to achieve temperatures below the ambient environment even under direct sunlight. At night, the absence of solar radiation further enhances the efficiency of heat dissipation. Integrating this technology with existing vapor-compression cooling systems improves their overall efficiency, achieving energy savings of 15% to 40%, depending on the specific application and the number of panels deployed.

The system's implementation involves coupling the cooling panels with the condenser unit of an air conditioning or refrigeration system. The panels serve as a pre-cooling mechanism for the refrigerant, reducing its temperature before entering the condenser. This pre-cooling reduces the workload on the compressor, thereby improving the system's coefficient of performance (COP). Additionally, the integration increases the cooling capacity, which is particularly beneficial during peak temperature periods when traditional systems may struggle to maintain efficiency.

A practical demonstration of this technology was conducted in a commercial setting, where an array of cooling panels was installed to reduce roof temperatures and create a large-scale heat radiator. This implementation significantly decreased the energy demands of refrigeration units, highlighting the system's potential for retrofitting existing infrastructure. The ability to improve energy efficiency and lower operational costs underscores the practicality and effectiveness of this technology in commercial applications.

This cooling approach addresses the growing global demand for energy-efficient cooling systems, which account for a substantial share of electricity consumption and contribute significantly to greenhouse gas emissions. By harnessing the natural cooling potential of the sky, this technology offers a scalable solution to mitigate the environmental impact of traditional cooling methods. The system's ability to operate independently of extensive electrical or water inputs aligns with broader goals of reducing energy consumption and promoting sustainability in cooling applications.

In summary, this advanced cooling technology represents a significant step forward in energy-efficient climate control. By utilizing radiative cooling principles, the panels enhance the performance of existing systems, reduce overall energy usage, and contribute to environmental sustainability. The demonstrated success in practical applications confirms its viability and effectiveness, making it a promising solution for modern cooling challenges. The following are some of the many practical examples disclosed herein.

In Example 1, an admixture for lightweight, high-performance concrete, comprising: a surfactant; and graphene; wherein when incorporated into a curable mixture and cured, results in a concrete that has: a compression strength that is greater than the compression strength of an otherwise identical cured curable mixture that excludes the admixture, the compressive strength being at least 3,000 psi; and a maximum density of about 150 lbs/ft3.

In Example 2, the admixture as Example 1 describes, wherein a cure time for the curable mixture is less than or equal to 28 days.

In Example 3, the admixture of any preceding claim, wherein the admixture is integrated into a concrete product formed using the admixture.

In Example 4, the admixture of any one as any of Examples 1-3 describe to 11 further comprising at least one of basalt, a polymeric material, and a foaming agent.

In Example 5, the admixture as any of Examples 1-4 describe, wherein the admixture one of a density-reducer admixture, a strength-increaser admixture, and a water-reducer admixture.

In Example 6, the admixture as any of Examples 1-5 describe, wherein incorporation of the density-reducer admixture into the curable mixture results in an increased R-value of the concrete than that of an otherwise identical concrete cured from a curable mixture that incorporates either the strength-increaser admixture or the water-reducer admixture.

In Example 7, the admixture as any of Examples 1-6 describe, wherein incorporation of the density-reducer admixture into the curable mixture results in a reduced time to 80% full strength of the concrete than that of an otherwise identical concrete cured from a curable mixture that incorporates either the strength-increaser admixture or the water-reducer admixture.

In Example 8, the admixture as any of Examples 1-7 describe, wherein the reduced time to 80% full strength is about 5 days.

In Example 9, the admixture as any of Examples 1-8 describe, wherein incorporation of the strength-increaser admixture into the curable mixture results in a concrete with at least one of: less time to full strength when cured than that of an otherwise identical curable mixture that incorporates the density-reducer admixture; and increased strength of the curable mixture when cured than that of an otherwise identical curable mixture that incorporates either the density-reducer admixture or the water-reducer admixture.

In Example 10, the admixture as any of Examples 1-9 describe, wherein the increased strength includes increased compressive and tensile strength.

In Example 11, the admixture as any of Examples 1-10 describe, wherein incorporation of the water-reducer admixture into the curable mixture results in a concrete with at least one of: less time to full strength when cured than that of an otherwise identical curable mixture that incorporates the density-reducer admixture; and increased time to full strength of the curable mixture when cured than that of an otherwise identical curable mixture that incorporates either the density-reducer admixture or the strength-increaser admixture.

In Example 12, the admixture as any of Examples 1-11 describe, wherein the increased time to full strength is about 25% increased time to full strength.

In Example 13, a concrete having constituents comprising: 2% to 6% of a cement; 4% to 8% of a sand; 83% to 87% of an aggregate; 1 to 5% of a water; 0_prd_05% to 0_prd_015% of a gypsum; and 0_prd_002% to 0_prd_006% of graphene, wherein the concrete has a time to full cure of less than or equal to 28 days and is 50 to 80% full strength with 5 days of cure time; and wherein the concrete has a compressive strength of greater than or equal to 3,000 psi at full cure.

In Example 14, the concrete as in any one as Example 13 describes and 14, further comprising 0_prd_1% to 5% basalt fiber.

In Example 15, a concrete having constituents comprising: 28% to 32% of a cement; 43% to 47% of a sand; 0_prd_5% to 1% of a Merlcrete; 19 to 21% of a water; 5% to 9% of a gypsum; and 0_prd_01% to 0_prd_005% % of graphene, wherein the concrete has a time to full cure of less than or equal to 28 days and is 50 to 80% full strength with 5 days of cure time; and wherein the concrete has a compressive strength of greater than or equal to 3,000 psi at full cure.

The relative percentage amounts of the aforementioned components will depend greatly upon the desired density of the final cementitious foam product or structure to be made. For example, lower density cementitious foams will likely have a smaller percentage of the cementitious slurry components, while higher relative density cementitious foams will have a greater percentage of the cementitious slurry components.

Exemplary percentage ranges for the aforementioned components are provided as set forth above. All percentages reflect solids of components based on total weight of these components and water into which the components are mixed for making the final cementitious foam slurry.

Although embodiments of the present disclosure have been described in detail, it should be understood that various changes, substitutions, and alterations can be made hereupon without departing from the principle and scope of the disclosure. Accordingly, the scope of the present disclosure should be determined by the following claims and their appropriate legal equivalents.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within the said range.

As used herein, the term “about” modifying the quantity or property refers to variation in the numerical quantity that can occur, for example, through typical measuring and handling procedures in the real world; through inadvertent error in these procedures; through differences in the manufacture, source, or purity of the ingredients employed to make the compositions or carry out the methods; and the like. In any case, the term “about” means within 10% of the reported numerical value, preferably within 5% of the reported numerical value.

Throughout this application, where patents or publications are referenced, the disclosures of these references in their entireties are intended to be incorporated by reference into this application, in order to more fully describe the state of the art to which the disclosure pertains, except when these references contradict the statements made herein.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations.

Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An admixture for lightweight, high-performance concrete, comprising:
a surfactant; and
graphene;
wherein when incorporated into a curable mixture and cured, results in a concrete that has:
a compression strength that is greater than the compression strength of an otherwise identical cured curable mixture that excludes the admixture, the compressive strength being at least 3,000 psi; and
a maximum density of about 150 lbs/ft³.

2. The admixture of claim 1, wherein a cure time for the curable mixture is less than or equal to 28 days.

3. The admixture of claim 1, wherein the admixture one of a density-reducer admixture, a strength-increaser admixture, and a water-reducer admixture.

4. The admixture of claim 3, wherein incorporation of the density-reducer admixture into the curable mixture results in an increased R-value of the concrete than that of an otherwise identical concrete cured from a curable mixture that incorporates either the strength-increaser admixture or the water-reducer admixture.

5. The admixture of claim 3, wherein incorporation of the density-reducer admixture into the curable mixture results in a reduced time to 80% full strength of the concrete than that of an otherwise identical concrete cured from a curable mixture that incorporates either the strength-increaser admixture or the water-reducer admixture.

6. The admixture of claim 5, wherein the reduced time to 80% full strength is about 5 days.

7. The admixture of claim 3, wherein incorporation of the strength-increaser admixture into the curable mixture results in a concrete with at least one of:
i. less time to full strength when cured than that of an otherwise identical curable mixture that incorporates the density-reducer admixture; and
ii. increased strength of the curable mixture when cured than that of an otherwise identical curable mixture that incorporates either the density-reducer admixture or the water-reducer admixture.

8. The admixture of claim 7, wherein the increased strength includes increased compressive and tensile strength.

9. The admixture of claim 3, wherein incorporation of the water-reducer admixture into the curable mixture results in a concrete with at least one of:
i. less time to full strength when cured than that of an otherwise identical curable mixture that incorporates the density-reducer admixture; and
ii. increased time to full strength of the curable mixture when cured than that of an otherwise identical curable mixture that incorporates either the density-reducer admixture or the strength-increaser admixture.

10. The admixture of claim 9, wherein the increased time to full strength is about 25% increased time to full strength.

11. The admixture of claim 1, wherein the admixture is integrated into a concrete product formed using the admixture.

12. The admixture of claim 1, further comprising at least one of basalt, a polymeric material, and a foaming agent.

13. A concrete having constituents comprising:
2% to 6% of a cement;
4% to 8% of a sand;
83% to 87% of an aggregate;
1 to 5% of a water;
0.05% to 0.015% of a gypsum; and
0.002% to 0.006% of graphene,
wherein the concrete has a time to full cure of less than or equal to 28 days and is 50 to 80% full strength with 5 days of cure time; and
wherein the concrete has a compressive strength of greater than or equal to 3,000 psi at full cure.

14. The concrete of claim 13, further comprising 0.1% to 5% basalt fiber.

15. A concrete having constituents comprising:
28% to 32% of a cement;
43% to 47% of a sand;
0.5% to 1% of a Merlcrete;
19 to 21% of a water;
5% to 9% of a gypsum; and
0.01% to 0.005% % of graphene,
wherein the concrete has a time to full cure of less than or equal to 28 days and is 50 to 80% full strength with 5 days of cure time; and
wherein the concrete has a compressive strength of greater than or equal to 3,000 psi at full cure.

14. The concrete of claim 15, further comprising 0.1% to 5% basalt fiber.
